(19) United States
(12) Patent Application Publication
(10) Pub. No.: US 2011/0290131 A1
(43) Pub. Date: Dec. 1, 2011

(54) STAMP

(75) Inventor: Hsu-Shen SHIH, YUAN KANG CITY (TW)

(73) Assignee: SUN SAME ENTERPRISES CO., LTD., YUAN KANG CITY (TW)

(21) Appl. No.: 12/790,674

(22) Filed: May 28, 2010

(51) Int. Cl. B41K 1/42

(52) U.S. Cl. 101/333

(57) ABSTRACT

A stamp has a frame, a stamp assembly and a skidproof assembly. The stamp assembly is mounted slidably on the frame. The skidproof assembly has four non-slip elements made of rubber and mounted respectively on the corners of the stamp assembly. Therefore, the skidproof assembly of the stamp prevents the stamp from slipping and increases steadiness of the stamp.

### BACKGROUND OF THE INVENTION

1. Field of the Invention

The present invention relates to a stamp, especially to a stamp having a skidproof assembly for improved steadiness.

2. Description of the Prior Art

With reference to FIG. 6, a conventional stamp comprises a handle assembly 90 and a stamp assembly 80.

The handle assembly 90 has a frame 92 and a handle 91.

The frame 92 is metal and durable and has two ends and two arms 93. The arms 93 are formed on and protrude respectively from the ends of the frame 92. The handle 91 is plastic and is mounted on the frame 92.

The stamp assembly 80 is metal and is mounted slidably between the arms 93 of the frame 92. The stamp assembly 80 has a shell 82, a tube 81 and a spring. The shell 82 has two supporting plates 83. The supporting plates 83 are mounted respectively on the arms 93 of the frame 92 and have a contact surface 84. The spring is mounted in the tube 81. The tube 81 is mounted slidably in the handle 91 of the frame 92.

With reference to FIGS. 7 and 8, the contact surfaces 84 of the conventional stamp contact a file 70, and the handle assembly 90 is pressed down to drive the stamp assembly 80 to stamp an image on the file 70.

Although the conventional stamp combines the metal frame 92 and the metal shell 82 to form a durable stamp, the contact surfaces 94 of the metal supporting plates 83 are smooth and slippery to cause failure and unsteadiness of stamping seals or images.

To overcome the shortcomings, the present invention provides a handle assembly of a stamp to mitigate or obviate the aforementioned problems.

### SUMMARY OF THE INVENTION

The main objective of the present invention is to provide a stamp that has a frame, a stamp assembly and a skidproof assembly. The stamp assembly is mounted slidably on the frame. The skidproof assembly has four non-slip elements made of rubber and mounted respectively on the corners of the stamp assembly. Therefore, the skidproof assembly of the stamp prevents the stamp from slipping and increases steadiness of the stamp.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a skidproof assembly of a stamp in accordance with the present invention;

FIG. 2 is a perspective view of the skidproof assembly in FIG. 1 mounted on a stamp assembly;

FIG. 3 is an operational front view of the skidproof assembly of the stamp in FIG. 1 showing stamping on a file;

FIG. 4 is a cross sectional top view of the skidproof assembly along line 4-4 in FIG. 3;

FIG. 5 is another perspective view of the skidproof assembly of the stamp in accordance with the present invention;

FIG. 6 is a perspective view of a conventional stamp in accordance with the prior art;

FIG. 7 is a front view of the conventional stamp in FIG. 6 showing stamping on a file; and

FIG. 8 is a cross sectional top view of the conventional stamp along line 8-8 in FIG. 7.

### DETAILED DESCRIPTION OF THE PREFERRED EMBODIMENTS

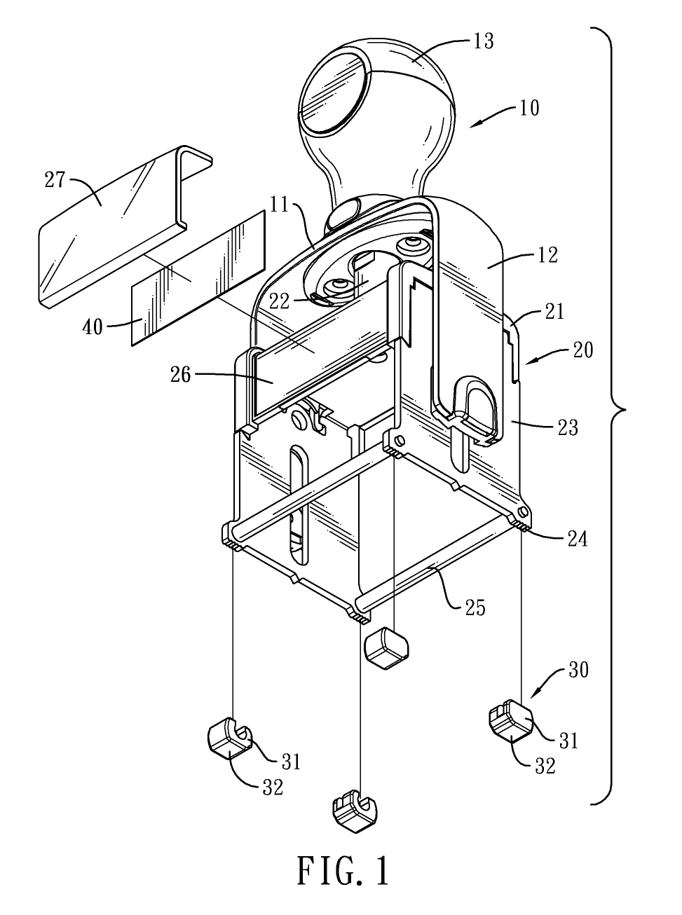

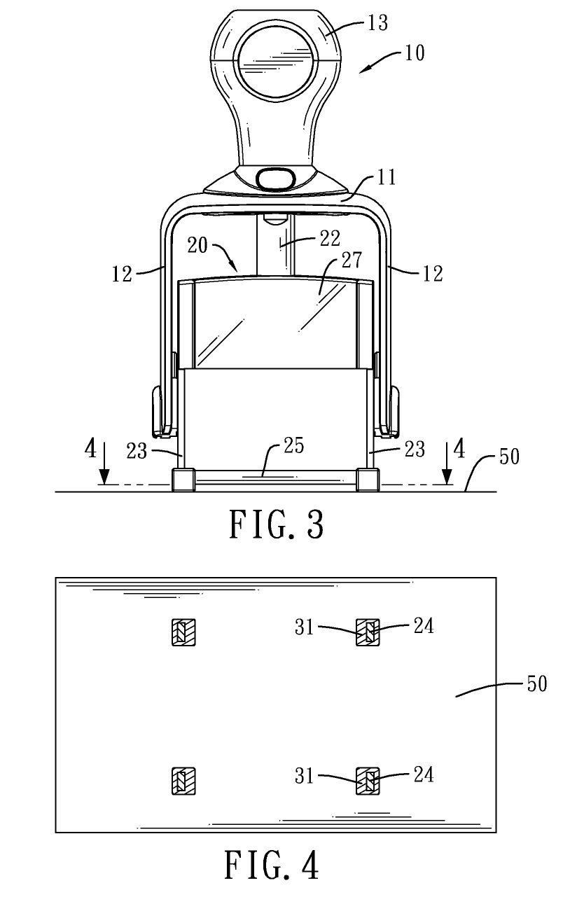

With reference to FIGS. 1 and 3, a stamp in accordance with the present invention comprises a frame 10, a stamp assembly 20 and a skidproof assembly 30.

The frame 10 is metal and has a basal plate 11, two arms 12 and a handle 13. The basal plate 11 has an outer surface and two opposite ends. The arms 12 are formed on and protrude respectively from the ends of the basal plate 11. The handle 13 is mounted on the outer surface of the basal plate 11.

The stamp assembly 20 is mounted slidably between the arms 12 of the frame 10. The stamp assembly 20 has a shell 21 and a tube 22. The shell 21 is metal and has an outer surface and two supporting plates 23. The outer surface has two opposite ends. The supporting plates 23 are formed respectively from the ends of the outer surface and are mounted slidably between the arms 12 of the frame 10. Each supporting plate 23 is rectangular and has a bottom edge and two corner connectors 24. The bottom edge is opposite to the tube 22 and has two ends. The corner connectors 24 are formed respectively on the ends of the bottom edge of the supporting plate 23. The tube 22 is hollow and protrudes from the outer surface of the shell 21. A spring is mounted in the tube 22. The tube 22 is mounted slidably into the handle 13 of the frame 10.

The skidproof assembly 30 is mounted on the stamp assembly 20 and has four non-slip elements 31. The non-slip elements 31 are rubber and are mounted respectively on the corner connectors 24 of the supporting plates 23. Each non-slip element 31 has a bottom and a contact surface 32 formed on the bottom.

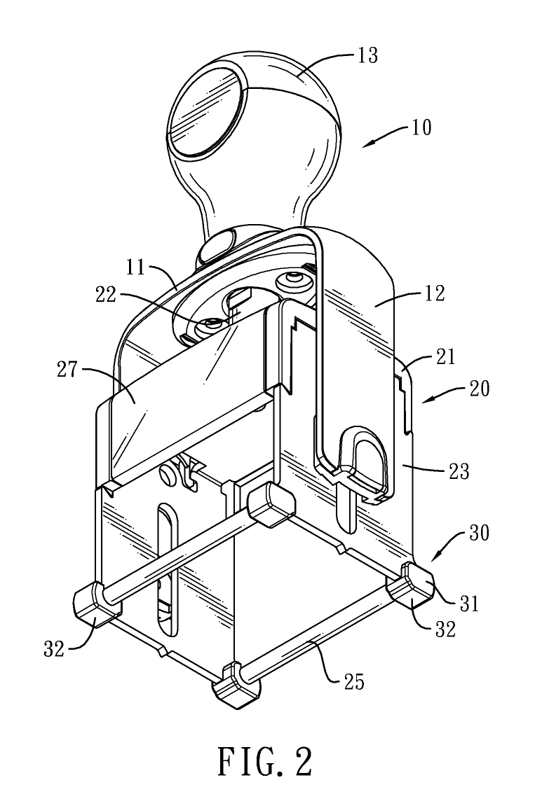

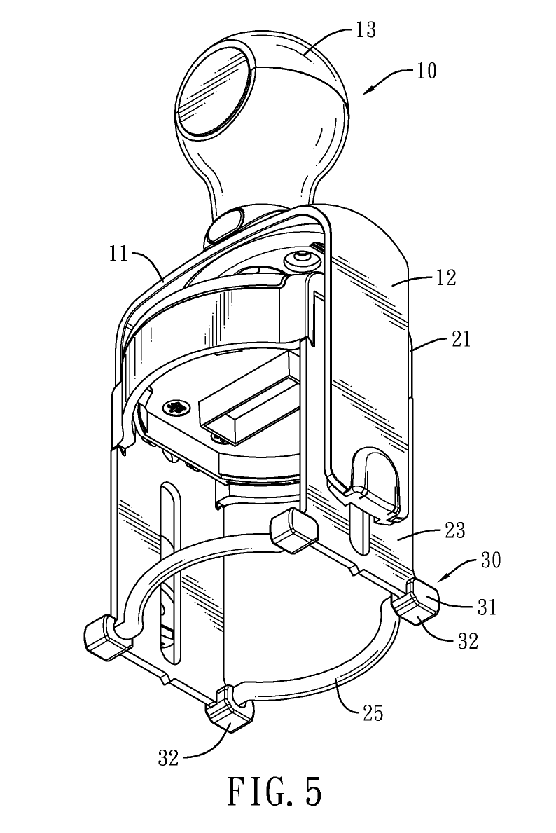

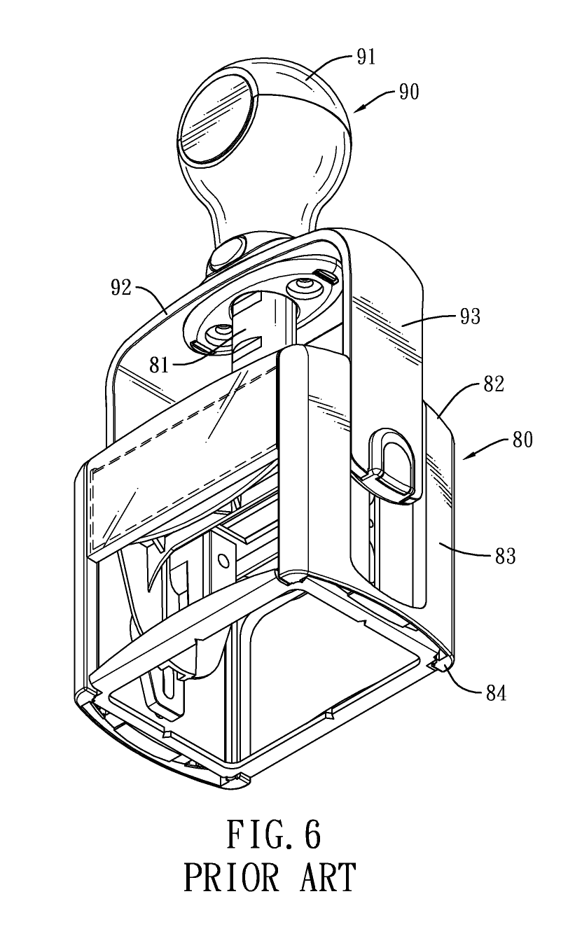

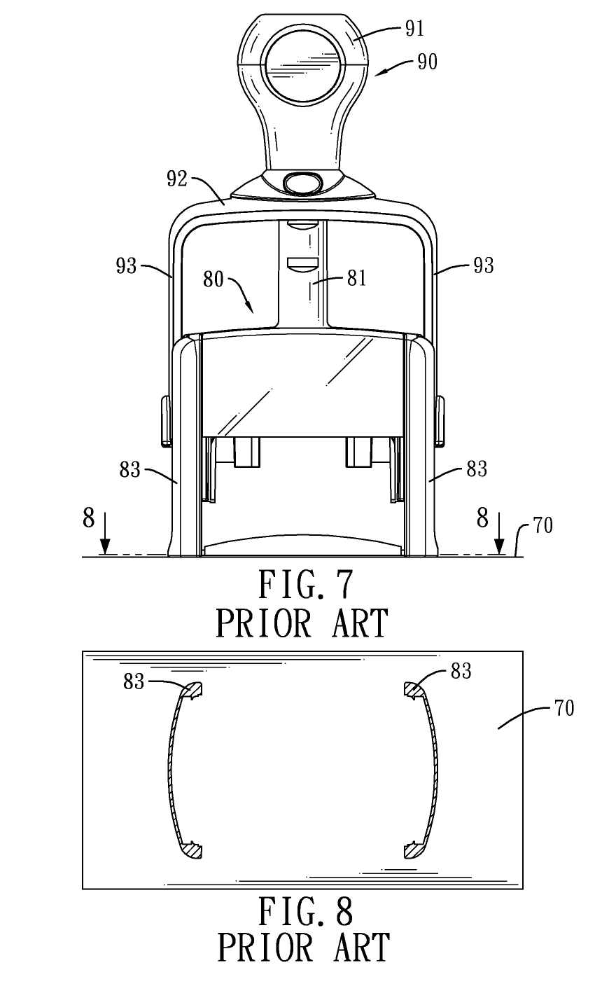

With further reference to FIGS. 2 and 5, the shell 21 of the stamp assembly 20 has two rods 25 mounted between the supporting plates 23 of the shell 21 and respectively adjacent to the corner connectors 24. The rods 25 of the shell 21 both may be straight or curved.

The stamp assembly 20 further has a mounting recess 26 formed in the shell 21 and a transparent cover 27 mounted on the mounting recess 26 of the shell 21. A label 40 is mounted in the mounting recess 26 and is covered by the transparent cover 27 to make a message on the label 40 readable through the transparent cover 27.

With further reference to FIGS. 3 and 4, when the stamp is put on a file 50, the contact surfaces 32 of the non-slip elements 31 contact the surface of the file to form a four-point support system.

The stamp as described has the following advantages. The stamp assembly 20 is mounted slidably on the frame 10. The non-slip elements 31 of the skidproof assembly 30 are rubber and are mounted respectively on the corners of the stamp assembly 20. The contact surfaces 32 of the non-slip elements 31 contact the surface of the file directly to form a four-point support system. Therefore, the skidproof assembly of the stamp prevents the stamp from slipping and increases steadiness when stamping images.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stamp comprising
a frame having
a basal plate having two ends;
two arms formed on and protruding respectively from the ends of the basal plate;
a handle formed on the basal plate;
a stamp assembly mounted slidably between the arms of the frame and having
a shell being metal and having
two supporting plates mounted respectively on the arms of the frame and each supporting plate having two corner connectors;
a tube protruding from the shell and mounted slidably into the handle of the frame;
a skidproof assembly having
four non-slip elements being rubber and mounted respectively on the corner connectors of the supporting plates and each non-slip element having
a bottom;
a contact surface formed on the bottom.

2. The stamp as claimed in claim 1, wherein the shell of the stamp assembly has two rods mounted between the supporting plates of the shell and respectively adjacent to the corner connectors.

3. The stamp as claimed in claim 2, wherein the rods of the shell are straight.

4. The stamp as claimed in claim 2, wherein the rods of the shell are curved.

5. The stamp as claimed in claim 1, wherein the stamp assembly further has a mounting recess formed on the shell and a transparent cover mounted on the mounting recess of the shell.

6. The stamp as claimed in claim 2, wherein the stamp assembly further has a mounting recess formed on the shell and a transparent cover mounted on the mounting recess of the shell.

7. The stamp as claimed in claim 3, wherein the stamp assembly further has a mounting recess formed on the shell and a transparent cover mounted on the mounting recess of the shell.
